(19) United States
(12) Patent Application Publication
(10) Pub. No.: US 2014/0095325 A1
(43) Pub. Date: Apr. 3, 2014

(54) OPTIMIZING MONETIZATION WITH BRAND IMPACT SCORING

(71) Applicants: Woo Jin Kim, San Francisco, CA (US); James Beser, Burlingame, CA (US); Bhavesh Mehta, Cupertino, CA (US); Brad Bender, New York, NY (US)

(72) Inventors: Woo Jin Kim, San Francisco, CA (US); James Beser, Burlingame, CA (US); Bhavesh Mehta, Cupertino, CA (US); Brad Bender, New York, NY (US)

(21) Appl. No.: 13/767,235

(22) Filed: Feb. 14, 2013

Related U.S. Application Data
(60) Provisional application No. 61/707,731, filed on Sep. 28, 2012.

(51) Int. Cl. G06Q 30/02

(52) U.S. Cl. CPC G06Q 30/0275
USPC 705/14.71

(57) ABSTRACT

Systems and methods for generating a bid for use in a content auction include providing brand-related content to a client device for presentation with first-party content. The method also includes receiving activity data indicative of online activity regarding the brand and analyzing the activity data to determine a brand impact score. The method further includes generating a content auction bid using the brand impact score.

### CROSS REFERENCE TO RELATED APPLICATIONS

The present application claims the benefit of U.S. Provisional Patent Application Ser. No. 61/707,731, filed Sep. 28, 2012, titled “Optimizing Monetization with Brand Impact Scoring,” which is hereby incorporated by reference herein in its entirety.

### BACKGROUND

The present disclosure relates generally to generating a bid in an online content auction. More specifically, the present disclosure relates to generating a bid in an online content auction based in part on a brand impact score.

Online content may be received from various first-party or third-party sources. In general, first-party content refers to the primary online content requested or displayed by the client device. For example, first-party content may be a webpage requested by the client or a stand-alone application (e.g., a video game, a chat program, etc.) running on the device. Third-party content, in contrast, refers to additional content that may be provided in conjunction with the first-party content. For example, third-party content may be a public service announcement or advertisement that appears in conjunction with a requested webpage (e.g., a search result webpage from a search engine, a webpage that includes an online article, a webpage of a social networking service, etc.) or within a stand-alone application (e.g., an advertisement within a game). More generally, a first-party content provider may be any content provider that allows another content provider (i.e., a third-party content provider) to provide content in conjunction with that of the first-party.

### SUMMARY

Implementations of the systems and methods for generating a bid in an auction are disclosed herein. One implementation is a method for generating a bid for use in a content auction. The method includes providing third-party content to a client device for presentation with first-party content, the third-party content being related to a brand. The method additionally includes receiving, at a processing circuit, activity data indicative of online activity regarding the brand, the activity data being indicative of an increase to search queries relating to the brand made at a search engine. The method also includes analyzing, by the processing circuit, the activity data to determine a brand impact score. The method further includes determining, by the processing circuit, an amount for a content auction bid using the brand impact score.

Another implementation is a system for generating a bid for use in a content auction comprising a processing circuit configured to provide third-party content to a client device for presentation with first-party content, the third-party content being related to a brand. The processing circuit is also configured to receive activity data indicative of online activity regarding the brand, the activity data being indicative of an increase to search queries relating to the brand made at a search engine. The processing circuit is additionally configured to analyze the activity data to determine a brand impact score. The processing circuit is further configured to determine an amount for a content auction bid using the brand impact score.

A further implementation is a computer-readable storage medium having machine instructions stored therein, the instructions being executable by a processor to cause the processor to perform operations. The operations include providing third-party content to a client device for presentation with first-party content, the third-party content being related to a brand. The operations also include receiving activity data indicative of online activity regarding the brand, the activity data being indicative of an increase to search queries relating to the brand made at a search engine. The operations additionally include analyzing the activity data to determine a brand impact score. The operations further include determining an amount for a content auction bid using the brand impact score.

These implementations are mentioned not to limit or define the scope of the disclosure, but to provide an example of an implementation of the disclosure to aid in understanding thereof. Particular implementations may be developed to realize one or more of the following advantages.

### BRIEF DESCRIPTION OF THE DRAWINGS

The details of one or more implementations are set forth in the accompanying drawings and the description below. Other features, aspects, and advantages of the disclosure will become apparent from the description, the drawings, and the claims, in which:

FIG. 1 is a block diagram of a computer system in accordance with a described implementation;

FIG. 2 is an illustration of an electronic display showing an example webpage;

FIG. 3 is an example process for generating a bid in a content auction; and

FIG. 4 is an example illustration of a brand impact score being used to generate a bid in a content auction.

Like reference numbers and designations in the various drawings indicate like elements.

### DETAILED DESCRIPTION

According to some aspects of the present disclosure, a first-party content provider may allow a content selection service to determine which third-party content is to be provided in conjunction with the first-party provider's content. One or more third-party content providers may also use the content selection service to provide third-party content in conjunction with content from any number of first-party providers. In some cases, the content selection service may dynamically select which third-party content is presented in conjunction with a first-party provider's content. For example, a first-party webpage may display different third-party content during different visits to the webpage. The content selection service may determine which third-party content is to be provided based on any number of factors (e.g., whether the third-party content and first-party content relate to the same topic). For example, a third-party advertisement for golf clubs may appear on a webpage devoted to reviews of golf resorts. The content selection service may also conduct a content auction to select the third-party content to be provided from among the various third-party content providers.

In some cases, third-party content selected by a content selection service may be interactive. For example, the third-party content may be a playable video or audio file. In another example, the third-party content may be a clickable image (e.g., a hotlinked image) configured to direct a web browser to an associated webpage when the image is selected. In response to an interaction with the third-party content at a client device, the content selection service may receive an indication of the interaction. For example, the content selection service may receive an indication that a user has clicked on a third-party image and was redirected to the third-party content provider's website.

A content selection service may use data indicative of interactions with third-party content in a number of ways. The content selection service may allow third-party content providers to bid in an auction based on whether a user interacts with the selected content. For example, a third-party content provider may place a bid in the auction that corresponds to an agreement to pay a certain amount of money if a user interacts with the provider's content (e.g., the provider may agree to pay $3 if the user clicks on the provider's content). The content selection service may also use content interaction data to determine the performance of the first-party provider's content. For example, users may be more inclined to click on third-party content on certain webpages over others. Auction bids to place third-party content may be higher for high-performing websites, while the bids may be lower for low-performing websites.

Certain types of products, services, etc., lend themselves to interactive third-party content. For example, an online retailer of books may use a content selection service to place images that are hotlinked to the retailer's website on a first-party webpage. A user interested in the retailer's content may click on the image, get redirected to the retailer's website, and then purchase a book from the retailer's website. However, interactive third-party content may not lend itself to other types of products, services, etc. For example, most users are unlikely to purchase a car online. In such cases, a third-party content provider may be more interested in increasing users' awareness of the provider's brand, than redirecting Internet traffic to the provider's website. Thus, certain third-party content providers may instead wish to provide third-party content that is not hotlinked (e.g., an impression-based piece of content) or is otherwise interactive. For example, a car manufacturer may simply wish to promote brand awareness online by including images of the manufacturer's products in conjunction with first-party content.

According to some implementations, a content selection service may be configured to quantify the impact of third-party content related to a particular brand by generating a brand impact score. Rather than basing the third-party content's impact on whether or not a user clicked on the content, the content selection service may use data indicative of any number of different types of online actions to determine whether the selected content increased a user's interest in the brand. Exemplary forms of data include, but are not limited to, data regarding traffic at the third-party's website, searches for the brand at a search engine, interactions with the third-party content, social networking actions regarding the brand, visits to webpages related to the brand, and other such data. For example, assume that a third-party content provider wishes to increase awareness of a new model of car and uses a content selection service to provide content regarding the car to users' devices. If the number of users that searched for the model of car increases after the content is provided, this may be a good indication that the users' interest in the brand has increased as a result of the third-party content being provided.

A brand impact score may be used by a content selection service in a variety of ways. In one implementation, a content selection service may use brand impact scores to conduct a content auction. For example, third-party content providers may compete in a content auction by placing bids for a particular brand impact score. In other words, an auction bid may correspond to an agreement to pay the content selection service a certain amount of money if the quantified interest in the brand is increased as a result of the third-party content being selected. Thus, the content selection service may be configured to conduct content auctions based on brand impact, in some implementations.

In various implementations, a content selection service may use a brand impact score to optimize the selection process. Once brand impact is quantified, a content selection service may optimize the generation of auction bids and matching of first-party and third-party content using brand impact scores. For example, a quality score may be associated with first-party content to quantify how likely third-party content provided in conjunction with the first-party content will affect interest in the brand. Similarly, a quality score may be associated with third-party content to quantify the overall performance of the content on increasing interest in the brand and/or regarding a specific piece of first-party content. For example, a quality score for the third-party content may be based in part on how well the third-party content has historically performed when selected for the first-party content, how relevant the third-party content is to the topic of the first-party content, and other such factors. In some implementations, the content selection service may use quality scores with auction bids to select third-party content. Thus, in some implementations, the content selection service may select high-quality content with a lower associated auction bid over low-quality content with a higher bid.

For situations in which the systems discussed herein collect personal information about a user, or may make use of personal information, the user may be provided with an opportunity to control which programs or features collect such information, the types of information that may be collected (e.g., information about a user's social network, social actions or activities, a user's preferences, a user's current location, etc.), and/or how third-party content may be selected by a content selection service and presented to the user. Certain data, such as a device identifier, may be anonymized in one or more ways before it is stored or used, so that personally identifiable information is removed when generating parameters (e.g., demographic parameters) used by the content selection service to select third-party content. For example, a device identifier may be anonymized so that no personally identifiable information about its corresponding user can be determined from it. In another example, a user's geographic location may be generalized where location information is obtained (such as to a city, ZIP code, or state level), so that a precise location of the user cannot be determined. Thus, the user may have control over how information is collected about him or her and used by the content selection service.

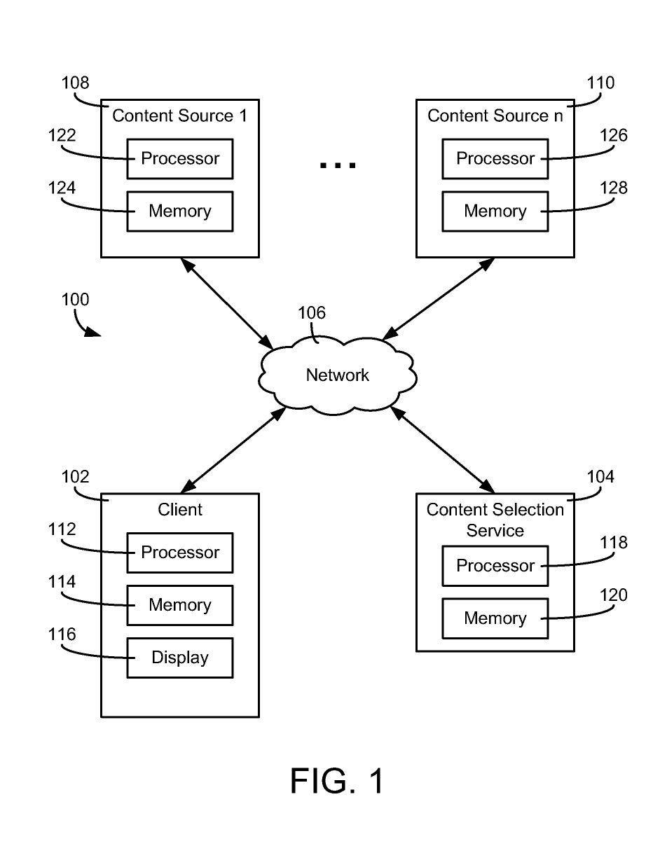

Referring to FIG. 1, a block diagram of a computer system 100 in accordance with a described implementation is shown. System 100 includes a client 102 which communicates with other computing devices via a network 106. Client 102 may execute a web browser or other application (e.g., a video game, a messenger program, a media player, a social networking application, etc.) to retrieve content from other devices over network 106. For example, client 102 may communicate with any number of content sources 108, 110 (e.g., a first content source through nth content source). Content sources 108, 110 may provide webpage data and/or other content, such as images, video, and audio, to client 102. Computer system 100 may also include a content selection service 104 configured to select third-party content to be provided to client 102. For example, content source 108 may provide a first-party webpage to client 102 that includes additional third-party content selected by content selection service 104.

Network 106 may be any form of computer network that relays information between client 102, content sources 108, 110, and content selection service 104. For example, network 106 may include the Internet and/or other types of data networks, such as a local area network (LAN), a wide area network (WAN), a cellular network, satellite network, or other types of data networks. Network 106 may also include any number of computing devices (e.g., computer, servers, routers, network switches, etc.) that are configured to receive and/or transmit data within network 106. Network 106 may further include any number of hardwired and/or wireless connections. For example, client 102 may communicate wirelessly (e.g., via WiFi, cellular, radio, etc.) with a transceiver that is hardwired (e.g., via a fiber optic cable, a CATS cable, etc.) to other computing devices in network 106.

Client 102 may be any number of different types of user electronic devices configured to communicate via network 106 (e.g., a laptop computer, a desktop computer, a tablet computer, a smartphone, a digital video recorder, a set-top box for a television, a video game console, combinations thereof, etc.). Client 102 is shown to include a processor 112 and a memory 114, i.e., a processing circuit. Memory 114 may store machine instructions that, when executed by processor 112 cause processor 112 to perform one or more of the operations described herein. Processor 112 may include a microprocessor, ASIC, FPGA, etc., or combinations thereof. Memory 114 may include, but is not limited to, electronic, optical, magnetic, or any other storage or transmission device capable of providing processor 112 with program instructions. Memory 114 may include a floppy disk, CD-ROM, DVD, magnetic disk, memory chip, ROM, RAM, EEPROM, EPROM, flash memory, optical media, or any other suitable memory from which processor 112 can read instructions. The instructions may include code from any suitable computer programming language such as, but not limited to, C, C++, C#, Java, JavaScript, Perl, HTML, XML, Python and Visual Basic.

Client 102 may include one or more user interface devices. A user interface device may be any electronic device that conveys data to a user by generating sensory information (e.g., a visualization on a display, one or more sounds, etc.) and/or converts received sensory information from a user into electronic signals (e.g., a keyboard, a mouse, a pointing device, a touch screen display, a microphone, etc.). The one or more user interface devices may be internal to the housing of client 102 (e.g., a built-in display, microphone, etc.) or external to the housing of client 102 (e.g., a monitor connected to client 102, a speaker connected to client 102, etc.), according to various implementations. For example, client 102 may include an electronic display 116, which displays webpages and other data received from content sources 108, 110 and/or content selection service 104. In various implementations, display 116 may be located inside or outside of the same housing as that of processor 112 and/or memory 114. For example, display 116 may be an external display, such as a computer monitor, television set, or any other stand-alone form of electronic display. In other examples, display 116 may be integrated into the housing of a laptop computer, mobile device, or other form of computing device having an integrated display.

Content sources 108, 110 may be one or more electronic devices connected to network 106 that provide content to devices connected to network 106. For example, content sources 108, 110 may be computer servers (e.g., FTP servers, file sharing servers, web servers, etc.) or combinations of servers (e.g., data centers, cloud computing platforms, etc.). Content may include, but is not limited to, webpage data, a text file, a spreadsheet, images, search results, other forms of electronic documents, and applications executable by client 102. Similar to client 102, content sources 108, 110 may include processing circuits comprising processors 122, 126 and memories 124, 128, respectively, that store program instructions executable by processors 122, 126. For example, the processing circuit of content source 108 may include instructions such as web server software, FTP serving software, and other types of software that cause content source 108 to provide content via network 106.

According to various implementations, content sources 108, 110 may provide webpage data to client 102 that includes one or more content tags. In general, a content tag may be any piece of webpage code associated with the action of including third-party content with a first-party webpage. For example, a content tag may define a slot on a webpage for third-party content, a slot for out of page third-party content (e.g., an interstitial slot), whether third-party content should be loaded asynchronously or synchronously, whether the loading of third-party content should be disabled on the webpage, whether third-party content that loaded unsuccessfully should be refreshed, the network location of a content source that provides the third-party content (e.g., content sources 108, 110, content selection service 104, etc.), a network location (e.g., a URL) associated with clicking on the third-party content, how the third-party content is to be rendered on a display, a command that causes client 102 to set a browser cookie (e.g., via a pixel tag that sets a cookie via an image request), one or more keywords used to retrieve the third-party content, and other functions associated with providing third-party content with a first-party webpage. For example, content source 108 may provide webpage data that causes client 102 to retrieve third-party content from content selection service 104. In another implementation, content may be selected by content selection service 104 and provided by content source 108 as part of the first-party webpage data sent to client 102. In a further example, content selection service 104 may cause client 102 to retrieve third-party content from a specified location, such as memory 114 or content sources 108, 110.

Similar to content sources 108, 110, content selection service 104 may be one or more electronic devices connected to network 106. Content selection service 104 may be a computer server (e.g., FTP servers, file sharing servers, web servers, etc.) or a combination of servers (e.g., a data center, a cloud computing platform, etc.). Content selection service 104 may have a processing circuit including a processor 118 and a memory 120 that stores program instructions executable by processor 118. In cases in which content selection service 104 is a combination of computing devices, processor 118 may represent the collective processors of the devices and memory 120 may represent the collective memories of the devices.

Content selection service 104 may be configured to select third-party content for client 102 (i.e., content selection service 104 may provide a third-party content selection service). In one implementation, the selected third-party content may be provided by content selection service 104 to client 102 via network 106. For example, content source 110 may upload the third-party content to content selection service 104. Content selection service 104 may then provide the third-party content to client 102 to be presented in conjunction with a first-party webpage provided by content source 108. In other implementations, content selection service 104 may provide an instruction to client 102 that causes client 102 to retrieve the selected third-party content (e.g., from memory 114 of client 102, from content source 110, etc.). For example, content selection service 104 may select third-party content to be provided as part of a first-party webpage being visited by client 102 or within a first-party application being executed by client 102 (e.g., within a game, messenger application, etc.).

In some implementations, content selection service 104 may be configured to select content based on a device identifier associated with client 102. In general, a device identifier refers to any form of data that may be used to represent a device or software that receives content selected by content selection service 104. In some implementations, a device identifier may be associated with one or more other device identifiers (e.g., a device identifier for a mobile device, a device identifier for a home computer, etc.). Device identifiers may include, but are not limited to, cookies, device serial numbers, user profile data, telephone numbers, or network addresses. For example, a cookie set on client 102 may be used to identify client 102 to content selection service 104.

Content selection service 104 may be configured to allow the user of client 102 to control which information about the user is collected and used by content selection service 104 via a device identifier. In addition, to the extent that content selection service 104 does collect and use information about the user, the data may be anonymized such that the user's identity cannot be determined by analyzing the collected data. In other words, the user of client 102 may control what types of information about the user is collected by content selection service 104 and how the information is used. In one embodiment, the user of client 102 may set one or more preferences (e.g., as part of an online profile) that control how content selection service 104 collects and uses information about the user. In another embodiment, content selection service 104 may set a cookie or other device identifier on client 102 that signifies that the user of client 102 has elected not to allow content selection service 104 to store information regarding him or her.

If the user of client 102 has elected to allow content selection service 104 to use information regarding him or her, content selection service 104 may use history data associated with a device identifier to select relevant content for the corresponding user. History data may be any data associated with a device identifier that is indicative of an online event (e.g., visiting a webpage, interacting with presented content, conducting a search, making a purchase, downloading content, etc.). Based in part on the analyzed history data, content selection service 104 may select third-party content to be provided in conjunction with first-party content (e.g., as part of a displayed webpage, as a pop-up, within a video game, within another type of application, etc.).

Content selection service 104 may analyze the history data associated with a device identifier to identify one or more topics that may be of interest. For example, content selection service 104 may perform text and/or image analysis on a webpage from content source 108, to determine one or more topics of the webpage. In some implementations, a topic may correspond to a predefined interest category used by content selection service 104. For example, a webpage devoted to the topic of golf may be classified under the interest category of sports. In some cases, interest categories used by content selection service 104 may conform to a taxonomy (e.g., an interest category may be classified as falling under a broader interest category). For example, the interest category of golf may be /Sports/Golf, /Sports/Individual Sports/Golf, or under any other hierarchical category.

Content selection service 104 may receive history data indicative of one or more online events associated with a device identifier. In implementations in which a content tag causes client 102 to request content from content selection service 104, such a request may include a device identifier for client 102 and/or additional information (e.g., the webpage being loaded, the referring webpage, etc.). Content selection service 104 may store such data to record a history of online events associated with a device identifier. In some cases, client 102 may provide history data to content selection service 104 without first executing a content tag. For example, client 102 may periodically send history data to content selection service 104 or may do so in response to receiving a command from a user interface device. In some implementations, content selection service 104 may receive history data from content sources 108, 110. For example, content source 108 may store history data regarding web transactions with client 102 and provide the history data to content selection service 104.

Content selection service 104 may apply one or more weightings to an interest or product category, to determine whether the category is to be associated with a device identifier. For example, content selection service 104 may impose a maximum limit to the number of product or interest categories associated with a device identifier. The top n-number of categories having the highest weightings may then be selected by content selection service 104 to be associated with a particular device identifier. A category weighting may be based on, for example, the number of webpages visited by the device identifier regarding the category, when the visits occurred, how often the topic of the category was mentioned on a visited webpage, or any online actions performed by the device identifier regarding the category. For example, topics of more recently visited webpages may receive a higher weighting than webpages that were visited further in the past. Categories may also be subdivided by the time periods in which the webpage visits occurred. For example, the interest or product categories may be subdivided into long-term, short-term, and current categories, based on when the device identifier visited a webpage regarding the category.

Content selection service 104 may receive data from content sources 108, 110 and/or client 102 to generate a brand impact score. Exemplary forms of data that may be received by content selection service 104 include, but are not limited to, data regarding traffic at the third-party's website, searches for the brand at a search engine, interactions with the third-party content, social networking actions regarding the brand, visits to webpages related to the brand, and other such data. Further exemplary forms of data may be indicative of users' engagement with the third-party content, how well the audience of the third-party content matches that of the first-party content, users' intensity and intent when browsing a particular first-party website, and the third-party content's reach (e.g., % of the audience reached), frequency (e.g., how frequently the third-party content was presented), or gross rating point (e.g., the product of the frequency and reach of the third-party content). In some implementations, the data may correspond temporally to when third-party content is selected by content selection service 104 for client 102. For example, the data may be indicative of actions performed at or within a certain amount of time after the content selection service selects the third-party content (e.g., within a minute, within ten minutes, within an hour, etc.).

Content selection service 104 may be configured to conduct a content auction among third-party content providers, to determine which third-party content is to be provided to a device identifier. For example, content selection service 104 may conduct a real-time content auction in response to client 102 requesting first-party content from one of content sources 108, 110 or executing a first-party application. Content selection service 104 may use any number of factors to determine the winner of the auction. For example, the winner of a content auction may be based in part on the third-party provider's bid and/or a quality score calculated using a brand impact score. In other words, the highest bidder is not necessarily the winner of a content auction conducted by content selection service 104, in some implementations. Such a quality score may be based in part on the historical brand impact scores for the third-party content when provided in conjunction with the first-party content, the effective brand impact score for the third-party content across all first-party content, or the overall brand impact score for the first-party content.

Content selection service 104 may use any number of optimization techniques to optimize the selection of third-party content. In one implementation, content selection service 104 may generate content auction bids on behalf of third-party content providers to achieve one or more specified goals (e.g., a targeted return on investment per quantity of brand impact). For example, a third-party content provider may specify to content selection service 104 a budget and target amount of brand impact that the provider would like to achieve. In such a case, content selection service 104 may predict the brand impact score that would result from a particular bid in a content auction to generate a bid on behalf of the third-party content provider. For example, content selection service 104 may use a feedback loop using brand impact scores to generate bids on behalf of the third-party content provider. Thus, content selection service 104 may be configured to steer a third-party content provider's bids away from first-party content predicted to have low brand impact for the third-party content. Similarly, high performing first-party content providers may be rewarded by such an optimization, since third-party bids generated by content selection service 104 may be higher for first-party content predicted to have a higher brand impact.

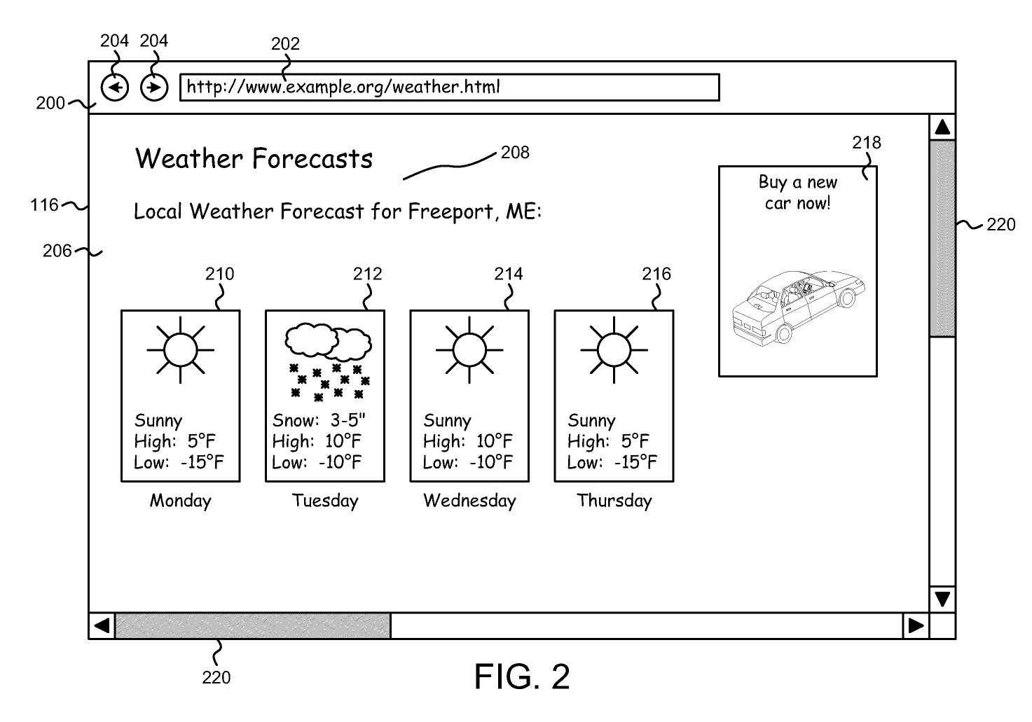

Referring now to FIG. 2, an illustration is shown of electronic display 116 displaying an example first-party webpage 206. Electronic display 116 is in electronic communication with processor 112 which causes visual indicia to be displayed on electronic display 116. As shown, processor 112 may execute a web browser 200 stored in memory 114 of client 102, to display indicia of content received by client 102 via network 106. In other implementations, another application executed by client 102 may incorporate some or all of the functionality described with regard to web browser 200 (e.g., a video game, a chat application, etc.).

Web browser 200 may operate by receiving input of a uniform resource locator (URL) via a field 202 from an input device (e.g., a pointing device, a keyboard, a touch screen, etc.). For example, the URL, http://www.example.org/weather.html, may be entered into field 202. Processor 112 may use the inputted URL to request data from a content source having a network address that corresponds to the entered URL. In other words, client 102 may request first-party content accessible at the inputted URL. In response to the request, the content source may return webpage data and/or other data to client 102. Web browser 200 may analyze the returned data and cause visual indicia to be displayed by electronic display 116 based on the data.

In general, webpage data may include text, hyperlinks, layout information, and other data that may be used to provide the framework for the visual layout of first-party webpage 206. In some implementations, webpage data may be one or more files of webpage code written in a markup language, such as the hypertext markup language (HTML), extensible HTML (XHTML), extensible markup language (XML), or any other markup language. For example, the webpage data in FIG. 2 may include a file, “weather.html” provided by the website, “www.example.org.” The webpage data may include data that specifies where indicia appear on first-party webpage 206, such as text 208. In some implementations, the webpage data may also include additional URL information used by web browser 200 to retrieve additional indicia displayed on first-party webpage 206. For example, the file, “weather.html,” may also include one or more instructions used by processor 112 to retrieve images 210-216 from their respective content sources.

Web browser 200 may include a number of navigational controls associated with first-party webpage 206. For example, web browser 200 may be configured to navigate forward and backwards between webpages in response to receiving commands via inputs 204 (e.g., a back button, a forward button, etc.). Web browser 200 may also include one or more scroll bars 220, which can be used to display parts of first-party webpage 206 that are currently off-screen. For example, first-party webpage 206 may be formatted to be larger than the screen of electronic display 116. In such a case, the one or more scroll bars 220 may be used to change the vertical and/or horizontal position of first-party webpage 206 on electronic display 116.

First-party webpage 206 may be devoted to one or more topics. For example, first-party webpage 206 may be devoted to the local weather forecast for Freeport, Me. In some implementations, a content selection server, such as content selection service 104, may analyze the contents of first-party webpage 206 to identify one or more topics. For example, content selection service 104 may analyze text 208 and/or images 210-216 to identify first-party webpage 206 as being devoted to weather forecasts. In some implementations, webpage data for first-party webpage 206 may include metadata that identifies a topic.

In various implementations, content selection service 104 may select some of the content presented on first-party webpage 206 (e.g., an embedded image or video, etc.) or in conjunction with first-party webpage 206 (e.g., in a pop-up window or tab, etc.). For example, content selection service 104 may select third-party content 218 to be included on webpage 206. In some implementations, one or more content tags may be embedded into the code of webpage 206 that defines a content field located at the position of third-party content 218. Another content tag may cause web browser 200 to request additional content from content selection service 104, when first-party webpage 206 is loaded. Such a request may include one or more keywords, a device identifier for client 102, or other data used by content selection service 104 to select content to be provided to client 102. In response, content selection service 104 may select third-party content 218 for presentation on first-party webpage 206.

Third-party content 218 may be related to a particular brand. For example, third-party content 218 may be related to a particular make or model of automobile, such as the Armadillo by Quartz Motor Company (QMC). In some implementations, content selection service 104 may select third-party content 218 by conducting a content auction. Content selection service 104 may select the provider of third-party content 218 based in part on a bid generated on behalf of the provider and/or a predicted brand impact score. For example, the provider of third-party content 218 may specify a target quantity of brand impact and budget to content selection service 104. Content selection service 104 may then predict the brand impact that would result from placing third-party content 218 on first-party webpage 206 and use the predicted brand impact to generate an auction bid on behalf of the provider. For example, content selection service 104 may use historical brand impact scores calculated from third-party content 218 being provided on first-party webpage 206 to calculate a quality score. Such a quality score may represent the likelihood of the user of client 102 becoming more interested in the brand as a result of third-party content 218 being selected.

In some implementations, content selection service 104 may provide third-party content 218 directly to client 102. In other implementations, content selection service 104 may send a command to client 102 that causes client 102 to retrieve third-party content 218. For example, the command may cause client 102 to retrieve third-party content 218 from a local memory, if third-party content 218 is already stored in memory 114, or from a networked content source. In this way, any number of different pieces of content may be placed in the location of third-party content 218 on first-party webpage 206. In other words, one user that visits first-party webpage 206 may be presented with third-party content 218 and a second user that visits first-party webpage 206 may be presented with different content. Other forms of content (e.g., an image, text, an audio file, a video file, etc.) may be selected by content selection service 104 for display with first-party webpage 206 in a manner similar to that of third-party content 218. In further implementations, content selected by content selection service 104 may be displayed outside of first-party webpage 206. For example, content selected by content selection service 104 may be displayed in a separate window or tab of web browser 200, may be presented via another software application (e.g., a text editor, a media player, etc.), or may be downloaded to client 102 for later use.

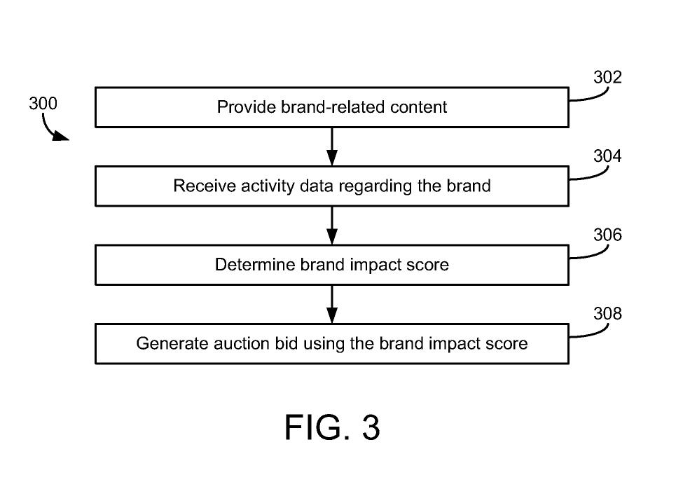

Referring now to FIG. 3, an example process 300 for generating a bid in a content auction is shown, according to various implementations. Process 300 may be performed by one or more computing devices, such as a content selection service or other computing devices associated with a content selection service. In general, process 300 allows the impact of third-party content related to a brand to be quantified as a brand-impact score. Using brand-impact scores, bids in content auctions on behalf of a third-party content provider may be generated to optimize the brand impact of the content selections.

Process 300 may include providing brand-related content to one or more client devices (block 302). In various implementations, the content may be selected by a content selection service for presentation in conjunction with first-party content. For example, the content selection service may select the brand-related content to be embedded on a first-party webpage being visited by a client device. The brand-related content may be provided to the client device either before a request for the first-party content or afterwards. For example, the brand-related content may be provided to the client device and the content selection service may cause the client to retrieve the brand-related content from a local memory.

Process 300 includes receiving activity data regarding the brand (block 304). In general, activity data refers to any data indicative of online activity regarding the brand from the provided content. In one example, activity data may be indicative of traffic lift (e.g., an increase in Internet traffic) to the third-party content provider's website or a webpage devoted to the brand (e.g., a “fan” website, a review website, etc.). In another example, activity data may be indicative of search lift regarding the brand (e.g., an increase to searches regarding the brand).

In a further example of activity data, the data may be indicative of traffic lift to an interest category related to the brand. In some implementations, an interest category profile may be generated for a device identifier based in part on topics of webpages visited by the device identifier. For example, assume that the device identifier visits a number of webpages devoted to four-door automobiles. Based on the webpage visits, the Interest category profile for the device identifier may include the interest category of /Autos & Vehicles/Body Styles/4 Doors. In some cases, the activity data may indicate that the number of device identifiers having the interest category in their Interest category profiles has increased in response to providing the brand-related content to client devices. In further cases, the activity data may indicate that a specific device identifier provided the brand-related content is now associated with the interest category.

The activity data may be indicative of various metrics regarding the brand-related content. Such metrics may be received directly or may be calculated using raw data regarding the brand-related content. In various implementations, the activity data may include metrics regarding how well the audience of the third-party content matches the audience of the first-party content, users' intensity and intent when browsing a particular first-party website, the reach of the third-party content, the frequency of the third-party content, or the gross rating point of the third-party content. The activity data may also be indicative of users' engagement with the third-party content (e.g., by interacting with the third-party content, if the content is interactive, rating up the third-party content via a social networking service, etc.).

In various implementations, the activity data may be from a historical time period or may correspond to a time period directly after the third-party content is provided. For example, the activity data may be indicative of brand-related activity within the first thirty seconds, first minute, first hour, etc. after the third-party content is provided to a client device. The activity data may also be generic to all device identifiers or may be indicative of activity performed by a specific device identifier provided the third-party content.

Process 300 includes determining a brand impact score using the activity data (block 306). In general, a brand impact score quantifies the effects of providing the third-party content to client devices. In some implementations, a brand impact score may be determined by summing or multiplying the various factors indicated by the activity data. For example, a brand impact score may be determined by adding the lift to the third-party provider's website to the search lift for the brand. Weighting and/or conversion values may also be applied to the various factors used to determine the brand impact score. For example, a higher weighting may be applied to social networking activity regarding the brand than for a general increase to device identifiers associated with a brand-related interest category. Conversion scores may also be used to standardize the factors when determining the brand impact score (e.g., to convert traffic lift values, social networking activity, etc. into values having the same scale).

A brand impact score may be indicative of brand impact based on the third-party content being provided to a specific device identifier or using activity data from a set of device identifiers. In some implementations, the brand impact score may be specific to the device identifier provided the third-party content. For example, a device identifier may be provided the third-party content and activity data attributable to the device identifier may be analyzed to determine the brand impact score. In other implementations, the brand impact score may be determined using activity data for those device identifiers that received the third-party content. In further implementations, the brand impact score may be generated using activity data generic to all device identifiers, including device identifiers that did not receive the third-party content (e.g., generic traffic lift data, etc.).

In some cases, the brand-related content provided in block 302 may be selected by a content selection service via a content auction. According to various implementations, a bid on behalf of the third-party content provider in the auction may be based on a brand impact score. Such a bid may be, for example, a cost per engagement (CPE) bid. In other words, the third-party content provider may agree to pay a certain amount of money in exchange for the brand-related content resulting in a specified brand impact score (e.g., a CPE bid may correspond to a cost per unit of brand impact). If the brand impact score is above a certain threshold, the provider's account with the content selection service may be debited in the amount of the corresponding bid.

Process 300 includes generating an auction bid using the brand impact score (block 308). Once the effects of the brand-related content have been quantified in a brand impact score, one or more quality scores may be generated based on brand impact scores. In general, a quality score may be any value that quantifies how much of an effect the third-party content has on users' interest in the brand. A quality score may be an average or other statistic (e.g., mean, median, etc.) of brand impact scores over a given time period. An associated confidence interval may also be calculated for such a statistic, to represent a degree of confidence in the statistic representing the true statistic for the population. For example, a 95% confidence interval may be a range of values in which the true average brand impact score may exist, with a 95% degree of confidence. In further implementations, a quality score may be a moving average of brand impact scores (e.g., a cumulative moving average, a weighted moving average, etc.).

A quality score may correspond to an average brand impact score for the third-party content, an average brand impact score for first-party content (e.g., an average brand impact score for third-party content provided in conjunction with the first-party content, or an average brand impact score for a specific pairing of third-party and first-party content. For example, assume that the third-party content is an advertisement for a particular brand of automobile, the QMC Armadillo. Also, assume that the content selection service selects the brand-related content to be provided on a particular website devoted to lacrosse a number of times. One possible quality score then may be an average of the brand impact scores that result from the brand-related content being placed on the website.

In various implementations, a quality score may be used to predict the potential brand impact score that would result from winning a particular content auction. For example, a first-party webpage having a low quality score may indicate that a low brand impact score may result, should the third-party content provider win an auction to place brand-related content on the first-party webpage. In other words, a quality score itself may correspond to a predicted brand impact score that would result from the third-party content provider winning a particular content auction. In other implementations, a quality score and/or historical brand impact scores may be used in a predictive model to determine the potential brand impact score that would result from the third-party content provider winning a content auction. Exemplary predictive models include, but are not limited to, neural networks and regression models (e.g., linear regression models, non-linear regression models, etc.).

A bid on behalf of the third-party content provider may be generated based in part on a predicted brand impact score. For example, a lower bid may be generated for a first-party website that is predicted to result in a lower brand impact score than for a first-party website that is predicted to result in a higher brand impact score. In implementations in which a generated bid is a CPE bid, a bid may not even be generated if the predicted brand impact score is outside of a given threshold. In some implementations, a feedback loop may be used to generate auction bids. Such a feedback loop may be configured to optimize auction bids subject to one or more constraints. For example, auction bids may be generated to optimize an average CPE for the third-party content provider, given a specified budget. In another example, the feedback loop may be configured such that the third-party content provider is steered towards first-party content that performs well and steered away from first-party content that performs poorly.

Additional auction parameters may also be used to generate content auction bids. Such parameters may include, but are not limited to, how well the topic of the third-party content matches a topic of the first-party content, whether a topic of the third-party content matches one specified by the third-party content provider, time-specific budgetary constraints specified by the third-party content provider (e.g., a daily budget, a monthly budget, etc.), a maximum auction bid specified by the third-party content provider, and a minimum auction bid specified by the third-party content provider. In cases in which a user has elected to provide anonymized information about his or her online activity, additional auction parameters may include a match between an interest category associated with a device identifier and an interest category specified by the third-party content provider. For example, a third-party content provider may specify that the brand-related content should be provided to those device identifiers associated with the interest category of /Entertainment/Hobbies/Photography.

Process 300 may be performed in real-time, partially in real-time, or over the course of time, in various implementations. In one implementation, block 308 may be performed in real-time in response to receiving a content selection request, while blocks 302-306 are performed at other times. For example, the brand-related content may be provided over a certain time period (e.g., a day, a week a month, etc.). Similarly, the activity data regarding the brand may be from a time period related to when the brand-related content is provided (e.g., in the hour, day, week, month, etc., after the brand-related content is provided). The brand-impact score may be determined using the activity data from any defined time period and may be recalculated at any time. For example, a brand-impact score may be determined as a nightly or weekly batch job. At a later time, the calculated brand-impact score may be used to determine an auction bid in a real-time content auction.

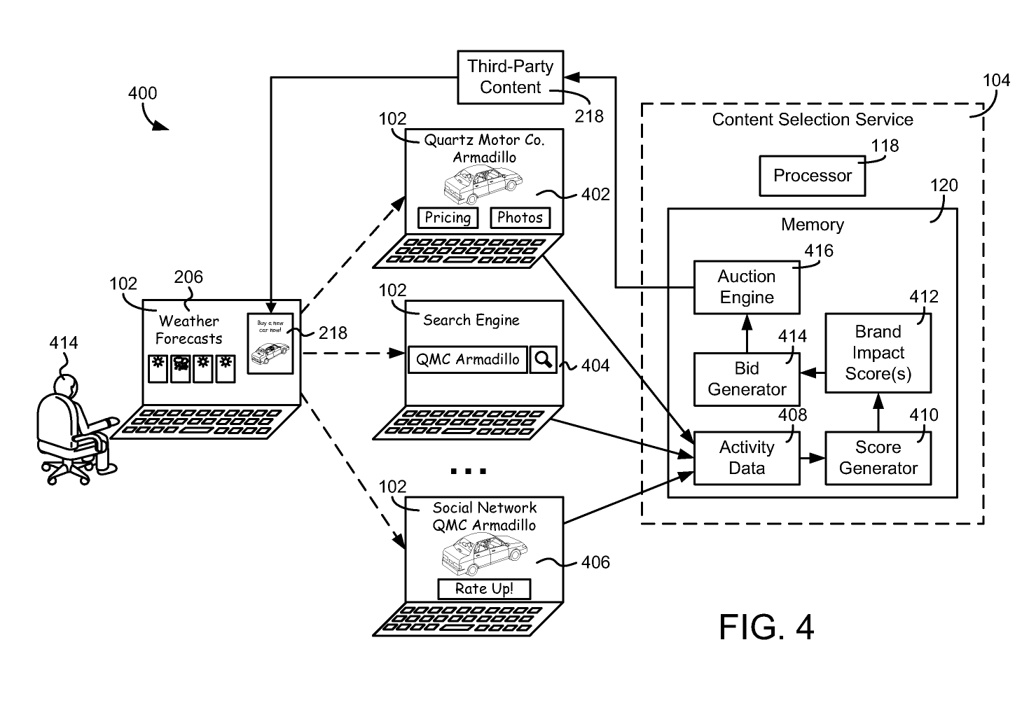

Referring now to FIG. 4, an example illustration 400 of a brand impact score being used to generate a bid in a content auction is shown, according to some implementations. In the example shown, content selection service 104 has selected third-party content 218 for display on client 102 as part of first-party webpage 206. As in the example of FIG. 2, third-party content 218 relates to a particular brand of automobile, the QMC Armadillo.

As a result of being presented third-party content 218, the interest of user 414 in the brand may be increased. User 414 may then perform any number of different online actions after visiting webpage 206 (e.g., a first through nth online action). In one example, user 414 may visit a website 402 operated by the third-party content provider that provides third-party content 218. For example, user 414 may be more interested in the QMC Armadillo as a result of third-party content 218 and visit webpage 402 to learn more about the automobile. In another example, user 414 may visit a search engine 404 and perform a search regarding the brand of automobile. In a further example, user 414 may visit a social networking website 406 and perform a social networking action such as rating up the brand of automobile or posting a message about the automobile.

Content selection service 104 may receive activity data 408 regarding the various brand-related activities that may result from providing third-party content 218. For example, activity data 408 may include data indicative of an increase to the number of brand-related searches at search engine 404 or an increase to the traffic at website 406. In another example, activity data 408 may include data indicative of an increase to the number of users that positively rated the brand via social networking website 406. Activity data 408 may be specific to a device identifier associated with client 102 or may be generic to all activity following the providing of third-party content 218.

In some implementations, memory 120 of content selection service 104 may include a score generator 410 configured to generate one or more brand impact scores 412 using activity data 408. Score generator 410 may, for example, use activity data 408 to determine the amount of lift indicated by activity data 408 (e.g., an increase to the traffic at website 404, brand related searches at search engine 404, etc.). If third-party content 218 is selected by content selection service 104 based on a CPE bid by the third-party content provider, the resulting brand impact score 412 may be compared to the bid. If the resulting brand impact score meets or exceeds that in the bid, the third-party provider's account may be debited by content selection service 104.

Memory 120 may also include a bid generator 414 configured to generate a bid in a content auction on behalf of the provider of third-party content 218. Such a generated bid may be based in part on brand impact scores 412. For example, bid generator 414 may determine a quality score for webpage 206 using brand impact scores 412 (e.g., an overall quality score for webpage 206 and/or a quality score for webpage 206 specific to when third-party content 218 is provided with it). If the quality score associated with webpage 206 is low, bid generator 414 may generate a lower auction bid or may not even generate a bid at all on behalf of the third-party content provider. In some implementations, bid generator 414 may use a predictive model to predict a brand impact score that would result from placing third-party content 218 on webpage 206. Additional factors that may be used by bid generator 414 include, but are not limited to, a target CPE specified by the provider of third-party content 218, an interest category, a topic of first-party content, or other such auction parameters.

Auction engine 416 of memory 120 may conduct a content auction to determine whether third-party content 218 is to be provided in conjunction with webpage 206. In some implementations, the auction may be conducted in real-time and in response to webpage 206 being visited. In other words, auction engine 416 may conduct an auction each time a user visits webpage 206, to select which third-party content is to be provided with it. If the bid generated by bid generator 414 on behalf of the third-party content provider is the winner of the auction, third-party content 218 may be selected for presentation with webpage 206. However, if the bid is not the winning bid, auction engine 416 may select different third-party content to be presented with webpage 206.

As shown, illustration 400 may illustrate a feedback loop and bid generator 414 may be configured to optimize the feedback loop by generating auction bids. For example, bid generator 414 may determine whether a given bid to place third-party content 218 on webpage 206 results in a higher or lower quality score for webpage 206 and/or for third-party content 218. Bid generator 414 may also generate auction bids to achieve a target CPE value and/or other target values (e.g., a specified budget, a specified minimum or maximum bid, etc.). For example, assume that the provider of third-party content 218 wishes to pay $3 per unit of brand impact. In such a case, bid generator 414 may increase or decrease bids for webpage 206 based in part on a predicted brand impact score derived from brand impact scores that previously resulted.

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on one or more computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium may be tangible.

The operations described in this specification can be implemented as operations performed by a data processing apparatus on data stored on one or more computer-readable storage devices or received from other sources.

The term “client or “server” include all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), OLED (organic light emitting diode), TFT (thin-film transistor), plasma, other flexible configuration, or any other monitor for displaying information to the user and a keyboard, a pointing device, e.g., a mouse, trackball, etc., or a touch screen, touch pad, etc., by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending webpages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The features disclosed herein may be implemented on a smart television module (or connected television module, hybrid television module, etc.), which may include a processing circuit configured to integrate Internet connectivity with more traditional television programming sources (e.g., received via cable, satellite, over-the-air, or other signals). The smart television module may be physically incorporated into a television set or may include a separate device such as a set-top box, Blu-ray or other digital media player, game console, hotel television system, and other companion device. A smart television module may be configured to allow viewers to search and find videos, movies, photos and other content on the web, on a local cable TV channel, on a satellite TV channel, or stored on a local hard drive. A set-top box (STB) or set-top unit (STU) may include an information appliance device that may contain a tuner and connect to a television set and an external source of signal, turning the signal into content which is then displayed on the television screen or other display device. A smart television module may be configured to provide a home screen or top level screen including icons for a plurality of different applications, such as a web browser and a plurality of streaming media services, a connected cable or satellite media source, other web “channels”, etc. The smart television module may further be configured to provide an electronic programming guide to the user. A companion application to the smart television module may be operable on a mobile computing device to provide additional information about available programs to a user, to allow the user to control the smart television module, etc. In alternate embodiments, the features may be implemented on a laptop computer or other personal computer, a smartphone, other mobile phone, handheld computer, a tablet PC, or other computing device.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking or parallel processing may be utilized.

What is claimed is:

1. A method for generating a bid for use in a content auction comprising:
providing third-party content to a client device for presentation with first-party content, the third-party content being related to a brand;
receiving, at a processing circuit, activity data indicative of online activity regarding the brand, the activity data being indicative of an increase to search queries relating to the brand made at a search engine;
analyzing, by the processing circuit, the activity data to determine a brand impact score; and
determining, by the processing circuit, an amount for a content auction bid using the brand impact score.

2. The method of claim 1, further comprising:
using the brand impact score to predict an amount of brand impact, wherein the amount for the content auction bid is determined based in part on the predicted amount of brand impact.

3. The method of claim 1, further comprising:
using the brand impact score to generate a quality score for the first-party content, wherein the amount for the content auction bid is determined based in part on the quality score for the first-party content.

4. The method of claim 1, wherein the content auction bid corresponds to a cost per unit of brand impact, and wherein the amount for the content auction bid is determined in order to optimize an average cost per unit of brand impact.

5. The method of claim 4, wherein the average cost per unit of brand impact is optimized using a feedback loop.

6. The method of claim 1, wherein the activity data comprises data indicative of an increase to search queries relating to the brand.

7. The method of claim 1, further comprising:
using the brand impact score to generate a quality score for the brand-related content, wherein the amount for content auction bid is determined based in part on the quality score for the brand-related content.

8. The method of claim 1, wherein the brand-related content is an impression-based advertisement that is not interactive.

9. A system for generating a bid for use in a content auction comprising a processing circuit configured to:
provide third-party content to a client device for presentation with first-party content, the third-party content being related to a brand;
receive activity data indicative of online activity regarding the brand, the activity data being indicative of an increase to search queries relating to the brand made at a search engine;
analyze the activity data to determine a brand impact score; and
determine an amount for a content auction bid using the brand impact score.

10. The system of claim 9, wherein the processing circuit is further operable to use the brand impact score to predict an amount of brand impact, wherein the amount for the content auction bid is determined based in part on the predicted amount of brand impact.

11. The system of claim 9, wherein the processing circuit is further operable to use the brand impact score to generate a quality score for the first-party content, wherein the amount for the content auction bid is determined based in part on the quality score for the first-party content.

12. The system of claim 9, wherein the content auction bid corresponds to a cost per unit of brand impact, and wherein the amount for the content auction bid is determined in order to optimize an average cost per unit of brand impact.

13. The system of claim 12, wherein the average cost per unit of brand impact is optimized using a feedback loop.

14. The system of claim 9, wherein the activity data comprises data indicative of traffic to a webpage devoted to the brand.

15. The system of claim 9, wherein the processing circuit is further configured to use the brand impact score to generate a quality score for the first-party content, wherein the amount for the content auction bid is generated based in part on the quality score for the first-party content.

16. The system of claim 9, wherein the third-party content is an impression-based advertisement that is not interactive.

17. A computer-readable storage medium having machine instructions therein, the instructions being executable by a processor to cause the processor to perform operations, the operations comprising:
providing third-party content to a client device for presentation with first-party content;
receiving activity data indicative of online activity regarding the brand, the activity data being indicative of an increase to search queries relating to the brand made at a search engine;
analyzing the activity data to determine a brand impact score; and
determining an amount for a content auction bid using the brand impact score.

18. The computer-readable storage medium of claim 17, wherein the amount for the content auction bid corresponds to a cost per unit of brand impact, and wherein the amount for the content auction bid is determined using a feedback loop configured to optimize an average cost per unit of brand impact.

19. The computer-readable storage medium of claim 17, wherein the activity data comprises data indicative of traffic to a webpage devoted to the brand.

20. The computer-readable storage medium of claim 17, wherein the content auction bid corresponds to a cost per unit of brand impact, and wherein the content auction bid is determined such that an average cost per unit of brand impact is optimized.
